(19) United States
(12) Patent Application Publication
(10) Pub. No.: US 2025/0172826 A1
(43) Pub. Date: May 29, 2025

(54) OPTICAL WAVEGUIDE AND MANUFACTURING METHOD OF OPTICAL WAVEGUIDE

(71) Applicants: ADVANTEST CORPORATION, Tokyo (JP); National Institute of Information and Communications Technology, Tokyo (JP)

(72) Inventors: Atsushi SEKI, Tokyo (JP); Akira OTOMO, Tokyo (JP); Yukihiro TOMINARI, Tokyo (JP)

(21) Appl. No.: 19/040,870

(22) Filed: Jan. 30, 2025

Related U.S. Application Data
(63) Continuation of application No. PCT/JP2022/039263, filed on Oct. 21, 2022.

(51) Int. Cl. G02F 1/01; G02F 1/00

(52) U.S. Cl. CPC G02F 1/0113; G02F 1/0018; G02F 2201/063; G02F 2202/10

(57) ABSTRACT

Provided is an optical waveguide, comprising: an optical propagation path containing an organic electro-optic polymer material; and a stacked structure covering at least a portion of the optical propagation path, having a first layer to prevent oxygen from permeating into the optical propagation path from outside, and a second layer to prevent moisture from permeating into the first layer from the outside. The first layer may contain Al₂O₃, and the second layer may contain SiO₂. The stacked structure may have a three-layer structure consisting of the second layer, the first layer, and a third layer that prevents moisture permeation from the optical propagation path to the first layer, stacked in sequence.

The contents of the following patent application(s) are incorporated herein by reference:
No. PCT/JP2022/039263 filed in WO on Oct. 21, 2022

### BACKGROUND

### 1. Technical Field

The present invention relates to an optical waveguide and a manufacturing method of the optical waveguide.

### 2. Related Art

In Patent Document 1, it is described that “in particular, since the present invention can follow organic optical materials by atomic layer deposition method, even organic optical materials with three-dimensional morphology can be formed with high adhesion and good thin films without pinholes, etc.” (paragraph 0115), “the components for forming thin films are not particularly limited and include, for example, oxides, nitrides, oxynitrides, and metals. One or more of these can be used alone or in combination” (paragraph 0122). In Patent Document 2, it is described that “the optical modulation unit 131 is composed of the EO polymer 232 coated by the dielectric film 240, the resin 250, and the plate component 260, so that the EO polymer 232 is not exposed to atmospheric oxygen” (paragraph 0035).

### PRIOR ART DOCUMENTS

### Patent Documents

Patent Document 1: Japanese Patent Application Publication No. 2017-8359

Patent Document 2: Japanese Patent Application Publication No. 2021-43263

### BRIEF DESCRIPTION OF THE DRAWINGS

FIG. 1 schematically illustrates a cross-sectional view of an optical waveguide 11 according to a first embodiment.

FIG. 2 schematically illustrates a cross-sectional view for describing an example of a manufacturing method of the optical waveguide 11 according to the first embodiment.

FIG. 3 schematically illustrates a cross-sectional view for describing an example of the manufacturing method of the optical waveguide 11 according to the first embodiment.

FIG. 4 schematically illustrates a cross-sectional view for describing an example of the manufacturing method of the optical waveguide 11 according to the first embodiment.

FIG. 5 schematically illustrates a cross-sectional view for describing an example of the manufacturing method of the optical waveguide 11 according to the first embodiment.

FIG. 6 schematically illustrates a cross-sectional view for describing an example of the manufacturing method of the optical waveguide 11 according to the first embodiment.

FIG. 7 schematically illustrates a cross-sectional view for describing an example of the manufacturing method of the optical waveguide 11 according to the first embodiment.

FIG. 8 schematically illustrates a cross-sectional view for describing an example of the manufacturing method of the optical waveguide 11 according to the first embodiment.

FIG. 9 illustrates a graph for describing evaluation results of optical power tolerance of the optical waveguide 11 according to the first embodiment.

FIG. 10 schematically illustrates a cross-sectional view of an optical waveguide 12 according to a second embodiment.

FIG. 11 schematically illustrates a cross-sectional view of an optical waveguide 13 according to a third embodiment.

FIG. 12 schematically illustrates a cross-sectional view of an optical waveguide 14 according to a fourth embodiment.

FIG. 13 schematically illustrates a cross-sectional view of an optical waveguide 15 according to a fifth embodiment.

FIG. 14 schematically illustrates a cross-sectional view of an optical waveguide 16 according to a sixth embodiment.

FIG. 15 schematically illustrates a cross-sectional view of an optical waveguide 17 according to a seventh embodiment.

### DESCRIPTION OF EXEMPLARY EMBODIMENTS

Hereinafter, the present invention will be described through embodiments of the invention, but the following embodiments do not limit the invention according to claims. In addition, not all of the combinations of features described in the embodiments are essential to the solutions of the invention.

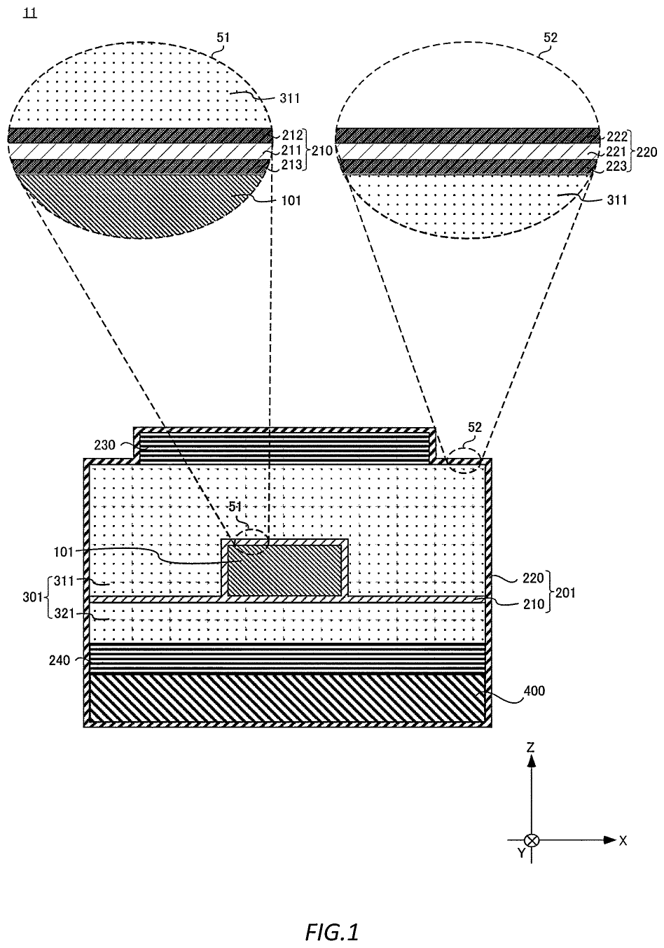

FIG. 1 schematically illustrates a cross-sectional view of an optical waveguide 11 according to a first embodiment. FIG. 1 illustrates an X axis, a Y axis, and a Z axis that are orthogonal to each other. In FIG. 1, an X-axis direction refers to a left-right direction as viewing toward a plane of paper, a Y-axis direction refers to a depth direction of the plane of paper, and a Z-axis direction refers to an up-down direction as viewing toward the plane of paper. In drawings subsequent to FIG. 1, the X, Y, and Z axes corresponding to the X, Y, and Z axes shown in FIG. 1 are illustrated, and redundant explanations are omitted. In the following description, the positive side in the X-axis direction may be referred to as right, the negative side in the X-axis direction may be referred to as left, the positive side in the Z-axis direction may be referred to as up, the negative side in the Z-axis direction may be referred to as down, and the Y-axis direction may be referred to as an optical propagation direction.

FIG. 1 schematically shows a virtual cut state of the optical waveguide 11 in an XZ plane, which is orthogonal to the optical propagation direction of the optical waveguide 11. The same applies to each cross-sectional view in drawings subsequent to FIG. 1, and redundant explanations are omitted.

The optical waveguide 11 propagates light that enters from one end while modulating the light inside, and then emits the light from the other end. The optical waveguide 11 is applicable, for example, to Mach-Zehnder-type optical switches or optical modulators placed on the transmitting side of an optical circuit. The optical waveguide 11 may propagate an optical on-off signal corresponding to a given electrical signal. When applied to optical switches or optical modulators, the optical waveguide 11 provides long-term resistance to great optical power to optical switches or optical modulators.

The optical waveguide 11 in the present embodiment includes an optical propagation path 101 that serves as a core of the optical waveguide 11, a stacked structure 201 that covers at least a portion of the optical propagation path 101, a cladding 301 that surrounds the perimeter of the optical propagation path 101, and a support substrate 400 with the cladding 301 formed on a main surface.

The optical propagation path 101 extends in the optical propagation direction of the optical waveguide 11 as the core of the optical waveguide 11. The optical propagation path 101, as an example, has a rectangular cross-section shape in the XZ plane orthogonal to the optical propagation direction. The dimensions of the rectangle are, as an example, 2 μm on the long side along the X-axis direction and 1.5 μm on the short side along the Z-axis direction.

The optical propagation path 101 includes organic electro-optic (EO, Electro Optic) polymer materials. The organic electro-optic polymer materials contain EO dyes. For example, the organic electro-optic polymer described in Japanese Patent Application Publication No. 2017-8359 may be used as the organic electro-optic polymer material. In the vicinity of the optical propagation path 101, for example, on the upper cladding 311 and on the support substrate 400, an upper electrode 230 and a lower electrode 240 are disposed. The upper electrode 230 and lower electrode 240 are, for example, indium zinc oxide (IZO, Indium Zinc Oxide) transparent electrodes. The organic electro-optic polymer material contained in the optical propagation path 101 changes its refractive index when a voltage is applied to the electrodes. As a result, the optical propagation path 101 can control the phase of light propagating in the optical propagation path 101. In the following description, the organic electro-optic polymer material may be referred to as organic EO polymer or simply referred to as EO polymer. The electrodes in the vicinity of the optical propagation path 101 may be disposed on the left and right sides of the cladding 301 instead of on the upper cladding 311 and the support substrate 400.

The stacked structure 201 has a first layer that prevents oxygen from permeating from the outside to the optical propagation path 101, and a second layer that prevents moisture from permeating from the outside to the first layer. The stacked structure 201 may further have a third layer that prevents moisture from permeating from the optical propagation path 101 to the first layer. The stacked structure 201 may also have a three-layer structure consisting of the second layer, the first layer, and the third layer stacked in sequence.

The stacked structure 201 is, as an example, located in at least a portion of the interface between the optical propagation path 101 and the cladding 301. In this case, the first layer described above prevents oxygen from permeating from the cladding 301 to the optical propagation path 101, and the second layer described above prevents moisture from permeating from the cladding 301 to the first layer. The stacked structure 201 may be located over the entire interface. In other words, the stacked structure 201 may cover the top, bottom, left, and right of the optical propagation path 101 extending in the optical propagation direction of the optical waveguide 11, that is, may cover the region other than the optical entering surface and the optical emitting surface of the optical propagation path 101.

The stacked structure 201 may also cover the optical entering surface and the optical emitting surface of the optical propagation path 101. The stacked structure 201 may also cover the outer surfaces of the cladding 301 and the support substrate 400.

In the present embodiment, the stacked structure 201 has a first stacked structure 210 and a second stacked structure 220. The stacked structure 201 may have a first stacked structure 210, but not have a second stacked structure 220.

The first stacked structure 210 is located over the entire interface between the optical propagation path 101 and the cladding 301. In other words, the first stacked structure 210 surrounds the perimeter of the optical propagation path 101. More specifically, the first stacked structure 210 surrounds the perimeter of the optical propagation path 101 in the cross section orthogonal to the optical propagation direction of the optical waveguide 11, as shown in FIG. 1. The first stacked structure 210 further surrounds the perimeter of the optical propagation path 101 over the entire optical propagation direction of the optical waveguide 11.

The first stacked structure 210 includes a first layer 211, a second layer 212 and a third layer 213, corresponding to the first layer, the second layer and the third layer described above. That is, the first stacked structure 210 has a three-layer structure consisting of the second layer 212, the first layer 211 and the third layer 213 stacked in sequence. More specifically, the first stacked structure 210 has the second layer 212, the first layer 211 and the third layer 213 stacked in sequence from the side opposing a side facing the optical propagation path 101. FIG. 1 shows an enlarged view of the region 51 indicated by dashed lines, which includes the three-layer structure of the first stacked structure 210.

The second stacked structure 220 covers the optical entering surface and the optical emitting surface of the optical propagation path 101, which are located at one end and the other end in the Y-axis direction of the optical propagation path 101. The second stacked structure 220 covers the outer surfaces of the cladding 301 and the support substrate 400 as shown in FIG. 1. In other words, the second stacked structure 220 covers the entire outer surface of the optical waveguide 11.

The second stacked structure 220 includes a first layer 221, a second layer 222 and a third layer 223, corresponding to the first layer, the second layer and the third layer described above. That is, the second stacked structure 220 has a three-layer structure consisting of the second layer 222, the first layer 221 and the third layer 223 stacked in sequence, similar to the first stacked structure 210. More specifically, the second stacked structure 220 has the second layer 222, the first layer 221 and the third layer 223 stacked in sequence from the outside of the optical waveguide 11. FIG. 1 shows an enlarged view of the region 52 indicated by dashed lines, which includes the second stacked structure 220 of the three-layer structure.

The first layer described above contains, for example, alumina (Al₂O₃). The second layer described above includes, for example, silicon dioxide (SiO₂). The third layer described above includes, for example, SiO₂.

The cladding 301 includes, for example, ultraviolet curable resin (UV resin). In the present embodiment, the cladding 301 has an upper cladding 311 and a lower cladding 321.

The upper cladding 311 and the lower cladding 321 are separated from each other in an up-down direction due to the optical propagation path 101 and the first stacked structure 210. The upper cladding 311 surrounds the upper, left and right sides of the perimeter of the optical propagation path 101 extending in the optical propagation direction of the optical waveguide 11, and the lower cladding 321 surrounds the lower side of the perimeter of the optical propagation path 101. The thickness of each of the upper cladding 311 and the lower cladding 321 in the Z-axis direction is 3 μm as an example.

The support substrate 400 is a plate component with main surfaces facing in the Z-axis direction. The support substrate 400 extends in the optical propagation direction of the optical waveguide 11. The lower cladding 321 is formed on the main surface on the positive side in the Z-axis direction of the support substrate 400. The lower cladding 321 may also be bonded onto the main surface of the support substrate 400. As shown in FIG. 1, a lower electrode 240 may be disposed between the support substrate 400 and the lower cladding 321. The support substrate 400 is formed of, for example, silicon or SiO₂. When it is described that the lower cladding 321 is formed on the main surface of the support substrate 400, the interposition of another component between the main surface of the support substrate 400 and the lower cladding 321 may also be included, for example, the interposition of the lower electrode 240 may also be included.

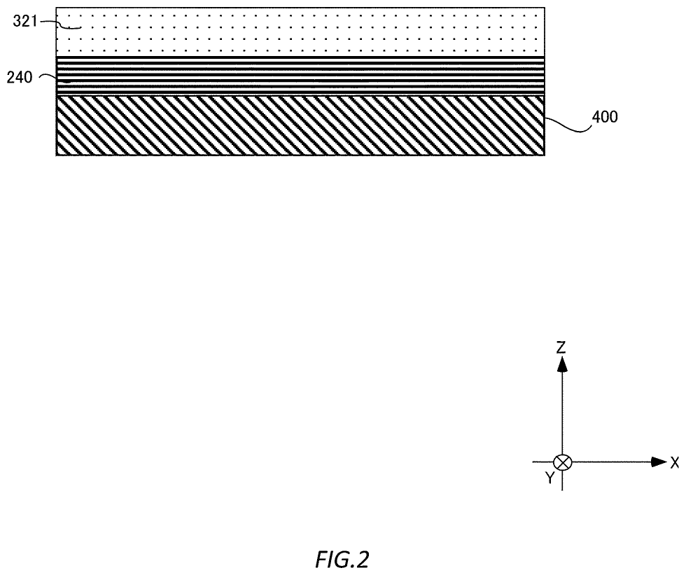

FIG. 2 to FIG. 8 are cross-sectional views for schematically describing examples of a manufacturing method of the optical waveguide 11 according to the first embodiment. The manufacturing method of the optical waveguide 11 may include preparing the support substrate 400 with the lower cladding 321 and the lower electrode 240 previously formed on the main surface on the positive side in the Z-axis direction, as shown in FIG. 2.

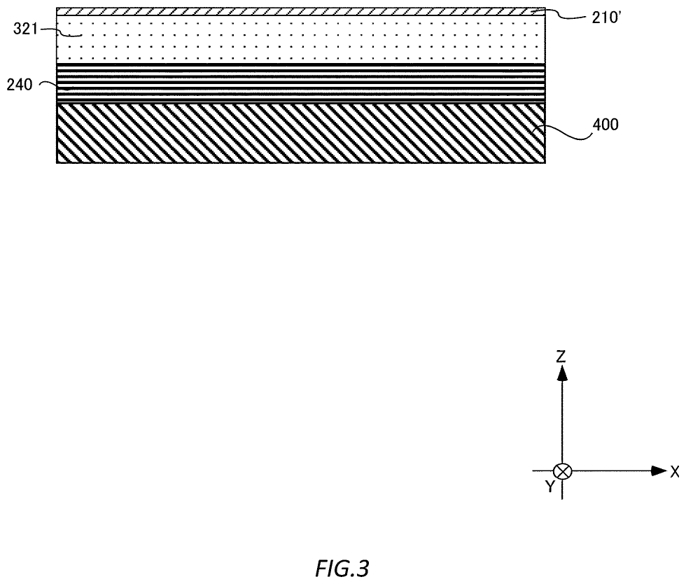

The manufacturing method of the optical waveguide 11 includes forming the optical propagation path 101 containing an EO polymer material. As shown in FIG. 3, forming the optical propagation path 101 may also include depositing a first stacked structure 210′, which is a precursor of the first stacked structure 210, on the lower cladding 321. More specifically, forming the optical propagation path 101 may include depositing the third layer 213, the first layer 211 and the second layer 212 in sequence on the lower cladding 321 by, for example, an Atomic Layer Deposition (ALD) equipment.

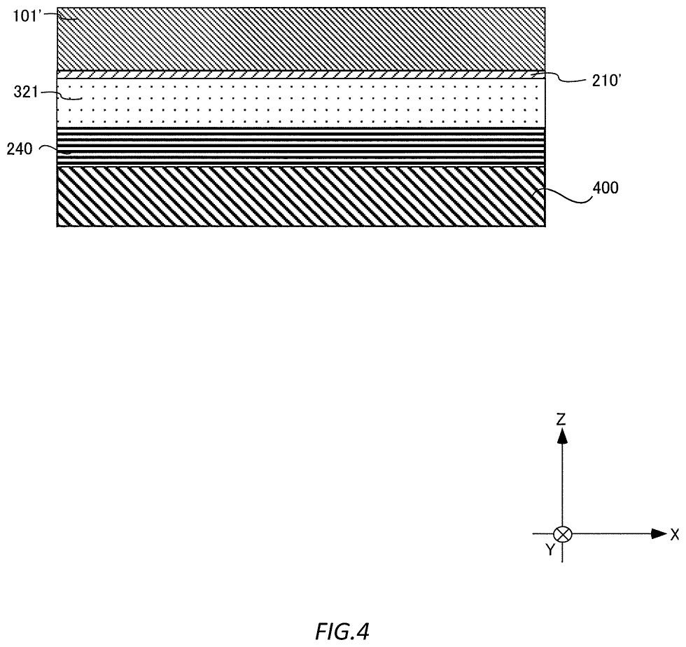

Forming the optical propagation path 101 may also include depositing and drying an optical propagation path 101′, which is a precursor of the optical propagation path 101, on the first stacked structure 210′, as shown in FIG. 4. Specifically, forming the optical propagation path 101 may include depositing and drying the EO polymer on the first stacked structure 210′ by spin-coating.

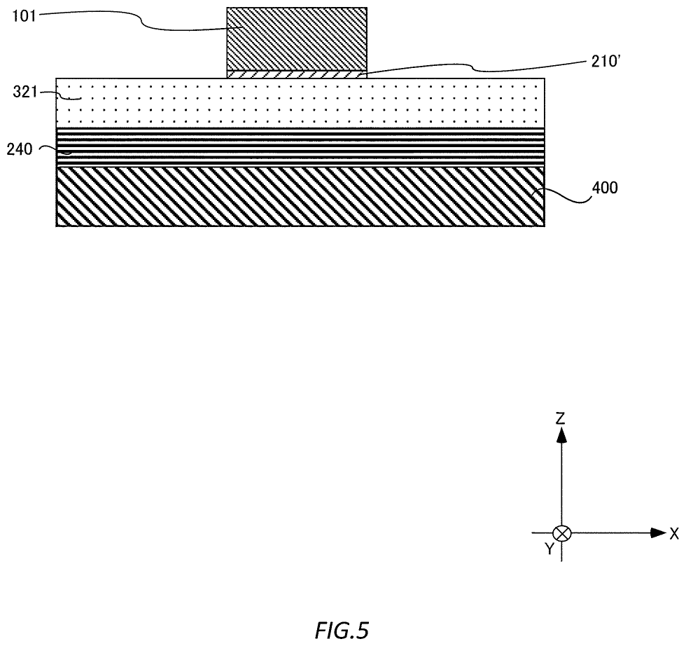

Forming the optical propagation path 101 may also include forming the optical propagation path 101 by processing the optical propagation path 101′ and the first stacked structure 210′ stacked on the lower cladding 321 collectively so that the cross-section shape in the XZ plane becomes a rectangle, as shown in FIG. 5. Specifically, forming the optical propagation path 101 may also include forming the optical propagation path 101 where the cross-section shape becomes a rectangle by etching mask on the optical propagation path 101′ to form photoresist patterns, and selectively removing the optical propagation path 101′ and the first stacked structure 210′ by dry etching or reactive etching. As a result, the first stacked structure 210 is located at the interface between the optical propagation path 101 and the lower cladding 321.

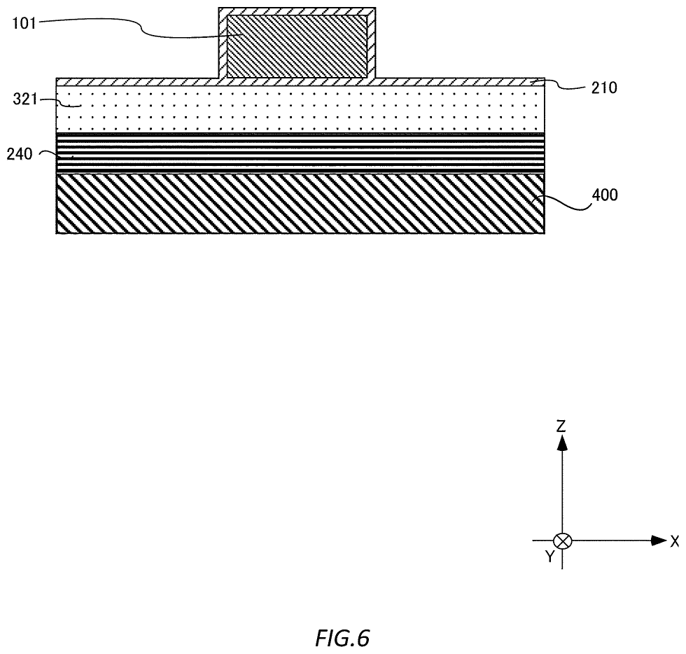

The manufacturing method of the optical waveguide 11 includes forming the stacked structure 201 covering at least a portion of the optical propagation path 101, with a first layer that prevents oxygen from permeating from the outside to the optical propagation path 101, and a second layer that prevents moisture from permeating from the outside to the first layer. Forming the stacked structure 201 may also include forming the first stacked structure 210 located at the interface between the optical propagation path 101 and the lower cladding 321 as shown in FIG. 3 to FIG. 5. Forming the stacked structure 201 may also include depositing the first stacked structure 210 on the lower cladding 321 and on the optical propagation path 101 as shown in FIG. 6. As a result, in the optical propagation path 101, the entirety including two ends of the optical propagation direction, may be covered by the first stacked structure 210.

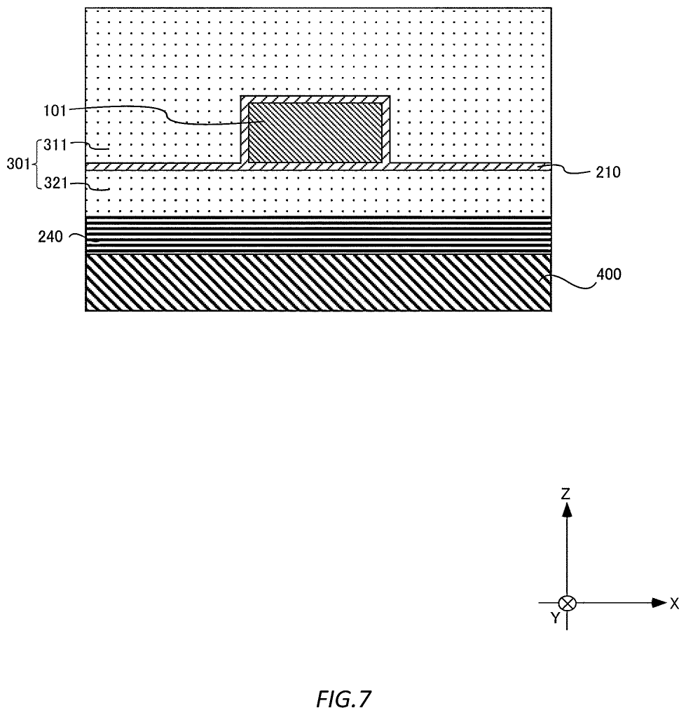

Forming the stacked structure 201 may also include forming the upper cladding 311 on the first stacked structure 210, as shown in FIG. 7. Specifically, forming the stacked structure 201 may also include depositing and drying the upper cladding 311 on the first stacked structure 210 by spin-coating.

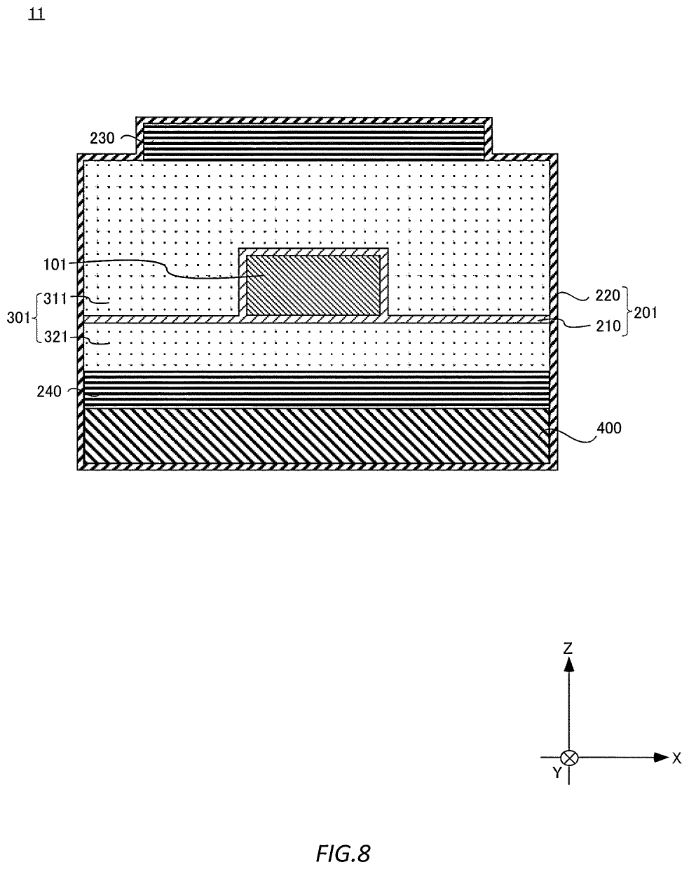

Forming the stacked structure 201 may also include forming the second stacked structure 220 that covers the outer surfaces of the cladding 301 and the support substrate 400, and the optical entering surface and the optical emitting surface of the optical propagation path 101 as shown in FIG. 8. Specifically, forming the stacked structure 201 may also include depositing the second stacked structure 220 to cover the entire optical waveguide 11.

Forming the stacked structure 201 may also include making an optical waveguide 11 applicable to optical switches or optical modulators by forming an upper electrode 230 or a wire on the cladding 301 before forming the second stacked structure 220, and removing the first stacked structure 210 covering the two ends to process the two ends to be exposed so that the light can enter and be emitted from the two ends of the optical propagation path 101 in the optical propagation direction. In this case, forming the second stacked structure 220 described above may also include forming the second stacked structure 220 that covers the upper electrode 230 in addition to the cladding 301 and so on.

As a comparative example 1 with respect to the optical waveguide 11 according to the first embodiment described above, assume an optical waveguide including an optical propagation path with the cross-section shape being a rectangle, formed from EO polymer containing EO dye, and a cladding directly surrounding the optical propagation path.

The cladding is deposited by using, for example, an organosilica film deposited by the Sol-Gel method or by using a sputtering equipment or a CVD equipment.

The cladding formed in this manner is easily permeable to oxygen.

In the optical waveguide of the comparative example 1, optical input to the optical propagation path causes fading due to oxidation of the EO dye at the interfaces of the optical propagation path, for example, at six surfaces including four surfaces at the top, bottom, left, and right, the optical entering surface, and the optical emitting surface. More specifically, in the optical waveguide of the comparative example 1, when light propagates in the optical propagation path, highly reactive singlet oxygen is excited by light energy or thermal energy during light absorption, and binds to the EO dye in the optical propagation path. This causes fading of the optical propagation path in the optical waveguide of the comparative example 1, which worsens the optical propagation loss by the optical waveguide. The fading may also be referred to as photo bleaching or refractive index change. In the following description, optical propagation loss may be referred to simply as optical loss.

The speed of worsening of the optical loss in the optical waveguide of the comparative example 1 is faster as the optical power input to the optical waveguide is stronger. That is, the optical waveguide of the comparative example 1 has low optical power tolerance.

Since the optical loss in the optical waveguide of the comparative example 1 is irreversible once it worsens, it is conceivable to prevent oxygen from contacting the EO dye in the optical propagation path in order to suppress the worsening of the optical loss. It is very difficult to manufacture a dense cladding with low oxygen permeability to prevent oxygen from contacting the EO dye in the optical propagation path.

As a comparative example 2 with respect to the optical waveguide 11 according to the first embodiment, assume an optical waveguide in which an antioxidant film with few lattice defects is deposited on the entire outer surface of the optical waveguide of the comparative example 1 by atomic layer deposition using an ALD equipment. In the optical waveguide of the comparative example 2, an Al₂O₃ film with low oxygen permeability is used as the antioxidant film.

In the optical waveguide of the comparative example 2, because the Al₂O₃ film formed by the ALD equipment is sensitive to moisture, when the optical waveguide of the comparative example 2 is used for a long time, moisture in the atmosphere causes a through-type defect called a pinhole in the Al₂O₃ film, which leads to progressive oxidation of the EO dye in the optical propagation path. Therefore, although the optical waveguide of the comparative example 2 has higher optical power tolerance when compared to the optical waveguide of the comparative example 1, the optical power tolerance is still low in the long term.

On the other hand, the optical waveguide 11 according to the first embodiment includes an optical propagation path 101 containing EO polymer and a stacked structure 201 having first layers 211, 221 that prevent oxygen from permeating from the outside to the optical propagation path 101, and second layers 212, 222 that prevent moisture from permeating from the outside to the first layers 211, 221. With the optical waveguide 11 having the configuration, the second layers 212, 222 can protect the first layers 211, 221 from moisture, and at the same time can suppress oxygen permeating toward the EO polymer contained in the optical propagation path 101. Accordingly, with the optical waveguide 11, the worsening of optical loss of the optical waveguide 11 can be suppressed over the long term, that is, the optical power tolerance can be maintained at a high level over the long term.

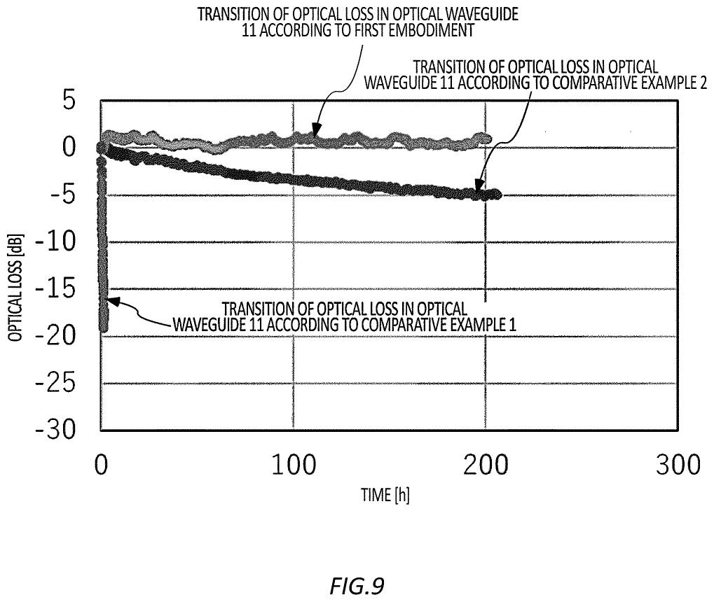

FIG. 9 is a graph describing evaluation results of the optical power tolerance of optical waveguide 11 according to the first embodiment. The horizontal axis of the graph refers to time [h], and the vertical axis of the graph refers to a total amount of the optical loss [dB]. In the following description, the total amount of optical loss simply may be referred to as the optical loss.

In the graph shown in FIG. 9, transition of the optical loss in the optical waveguide according to the comparative example 1 described above, transition of the optical loss in the optical waveguide according to the comparative example 2 described above, and transition of the optical loss in the optical waveguide 11 according to the first embodiment are each shown by plot data.

In the evaluation of FIG. 9, as the optical waveguide 11 according to the first embodiment, the stacked structure 201 further has third layers 213, 223 that prevent moisture from permeating from the optical propagation path 101 to the first layers 211, 221 in addition to the first layers 211, 221 and the second layers 212, 222, and uses a three-layer structure where the second layers 212, 222, the first layers 211, 221 and the third layers 213, 223 stacked in sequence. More specifically, as the optical waveguide 11 according to the first embodiment, the second layers 212, 222, the first layers 211, 221 and the third layers 213, 223 of the stacked structure 201 use multi-layered films consisting of SiO₂, Al₂O₃, SiO₂ formed in the ALD equipment, with a film thickness of each layer of SiO₂, Al₂O₃, SiO₂ being 20 nm.

In the evaluation of FIG. 9, in the optical waveguide according to the comparative example 1, a relatively low power of 10 mW is applied to the optical input, and in the optical waveguide according to the comparative example 2 and in the optical waveguide 11 according to the first embodiment, 35 mW is applied to the optical input.

As shown in FIG. 9, with the optical waveguide according to the comparative example 1, it is confirmed that optical loss worsens quickly immediately after the optical input. With the optical waveguide according to the comparative example 2, the optical loss is moderate until about 4 hours after the start of the optical input, after which the worsening of the optical loss accelerates, and about 5 dB of optical loss is confirmed in about 10 days.

On the other hand, with the optical waveguide 11 according to the first embodiment, the optical loss hardly worsens even after about 10 days, and it is confirmed that the optical power tolerance can be maintained at a high level over long term. With the optical waveguide 11 according to the first embodiment, it is possible to suppress direct contact of moisture in the atmosphere with the first layers 211, 221 of the stacked structure 201, that is, pinholes are suppressed in the first layers 211, 221, thereby it is assumed that an antioxidantion effect of the EO dye contained in the EO polymer in the optical propagation path 101 can be sustained.

Moisture may be contained inside the EO polymer of the optical propagation path 101, and when the stacked structure 201 is returned to room temperature after deposition in a low-temperature process of about 100° C. using the ALD equipment, the moisture may spread to the first layers 211, 221 and cause pinholes in the first layers 211, 221. Therefore, it is assumed that the optical waveguide 11 according to the first embodiment can prevent moisture from permeating from the EO polymer of the optical propagation path 101 to the first layers 211, 221, and can further sustain the antioxidantion effect described above, by making the stacked structure 201 a three-layer structure including the third layers 213, 223.

As evaluated in FIG. 9, the thickness of each layer of the stacked structure 201 may be, for example, 20 nm. The thickness of each layer of the stacked structure 201 may make the second layers 212, 222 and the third layers 213, 223 1 nm, and the first layers 211, 221 2 nm. The thickness of the stacked structure 201 may be from 4 nm to 100 nm. As the reason, when making the second layers 212, 222 and the third layers 213, 223 be less than 1 nm, and/or the first layers 211, 221 be less than 2 nm in the stacked structure 201, the possibility that the inhibitory effect of oxygen permeation by the first layers 211, 221 reduces becomes higher, and when making the thickness of the stacked structure 201 thicker than 100 nm, the possibility of cracks in each layer or the possibility of affecting optical propagation in the optical propagation path 101 increases becomes higher. The thickness of each layer of the stacked structure 201 may be the same as or different from each other, for example, the thickness of the outermost stacked second layers 212, 222 may be relatively thicker.

As described above, in the optical waveguide 11 according to the first embodiment, each layer of the stacked structure 201 may be formed by the ALD equipment. As an evaluation result of mean surface roughness by an atomic force microscopy (AFM), when the SiO₂ film with a film thickness of 20 nm is formed at 100 deg by the ALD equipment, a result that arithmetic mean roughness (Ra) is 0.14 nm, root mean square roughness (RMS) is 0.18 nm, and maximum height difference is 0.9 nm is obtained. When the Al₂O₃ film with a film thickness of 20 nm is formed at 100 deg by the ALD equipment, a result that Ra is 0.17 nm, RMS is 0.22 nm, and maximum height difference is 0.9 nm is obtained. From these evaluation results, it is understood that by forming each layer of the stacked structure 201 by the ALD equipment, it is possible to form a stacked structure 201 with very good planarity and few defects.

In the optical waveguide 11 according to the first embodiment, the first stacked structure 210 and the second stacked structure 220 of the stacked structure 201 are described to have the second layers 212, 222 and the third layers 213, 223 formed of the same material as each other, for example, a material containing SiO₂. The second stacked structure 220 of the stacked structure 201 is formed at a place relatively further from the optical propagation path 101 where light propagates when compared to the first stacked structure 210, for example, on the optical entering surface and the optical emitting surface of the optical propagation path 101, and the outer surfaces of the cladding 301 and the support substrate 400, thereby the second layer 222 and the third layer 223 may contain materials different from each other. More specifically, the third layer 223 of the second stacked structure 220 contains SiO₂, on the other hand, the outermost second layer 222 may contain silicon nitride (SiN). In this case, in the three-layer structure of the second stacked structure 220, each layer becomes to contain a different material from each other, for example, SiN, Al₂O₃, SiO₂ may be stacked in sequence from the outside.

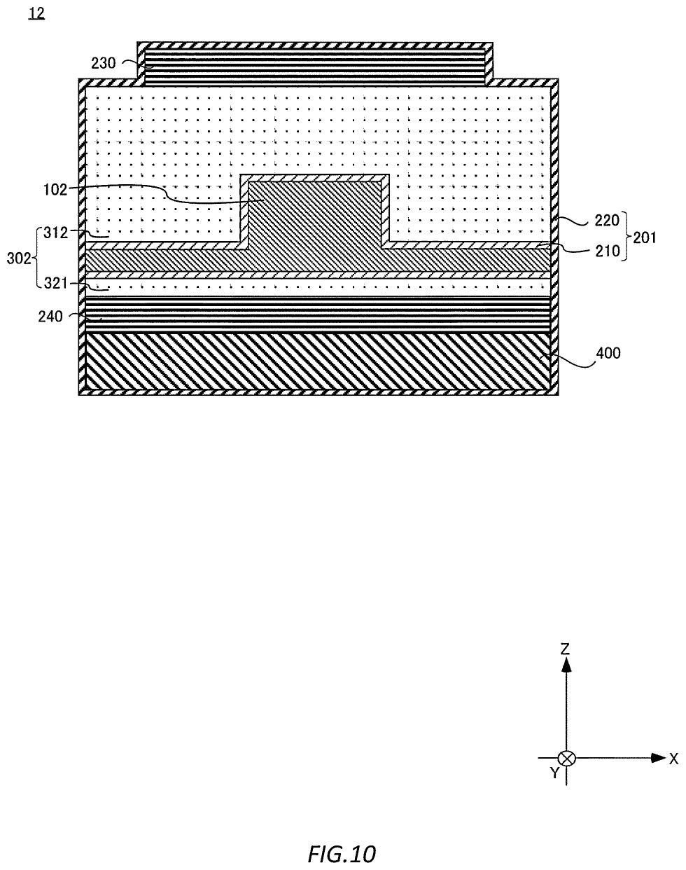

FIG. 10 schematically illustrates a cross-sectional view of an optical waveguide 12 according to a second embodiment. The optical waveguide 12 according to the second embodiment includes an optical propagation path 102 with a cross section in an upper convex shape instead of the optical propagation path 101 with a rectangle cross section, which is a different point from the optical waveguide 11 according to the first embodiment. In the optical waveguide 12 according to the second embodiment, the cladding 302 has an upper cladding 312 instead of the upper cladding 311, which is a further different point from the optical waveguide 11 according to the first embodiment.

Other configurations of the optical waveguide 12 according to the second embodiment are the same as those of the optical waveguide 11 according to the first embodiment, and the same reference numbers as the corresponding configurations in the optical waveguide 11 according to the first embodiment are used, and redundant explanations are omitted. The same applies to the description of the subsequent embodiments, and redundant explanations are omitted.

The optical waveguide 12 with an optical propagation path 102 that has an upper convex shape in a cross section orthogonal to the optical propagation direction can also be referred to as a ridge-type optical waveguide 12 because the protruding portion of the optical propagation path 102 extends in the optical propagation direction like a ridge. The ridge-type optical waveguide 12 can ensure single-mode propagation even if the left-right width of the optical propagation path 102 through which light propagates is relatively large, and thus may be operable in visible light. In the optical waveguide 12 according to the second embodiment, the upper cladding 312 surrounds the upper side of the optical propagation path 102 covered by the first stacked structure 210, and the lower cladding 321 surrounds the lower side of the optical propagation path 102 covered by the first stacked structure 210.

The same effect as the optical waveguide 11 according to the first embodiment can also be obtained by the optical waveguide 12 according to the second embodiment.

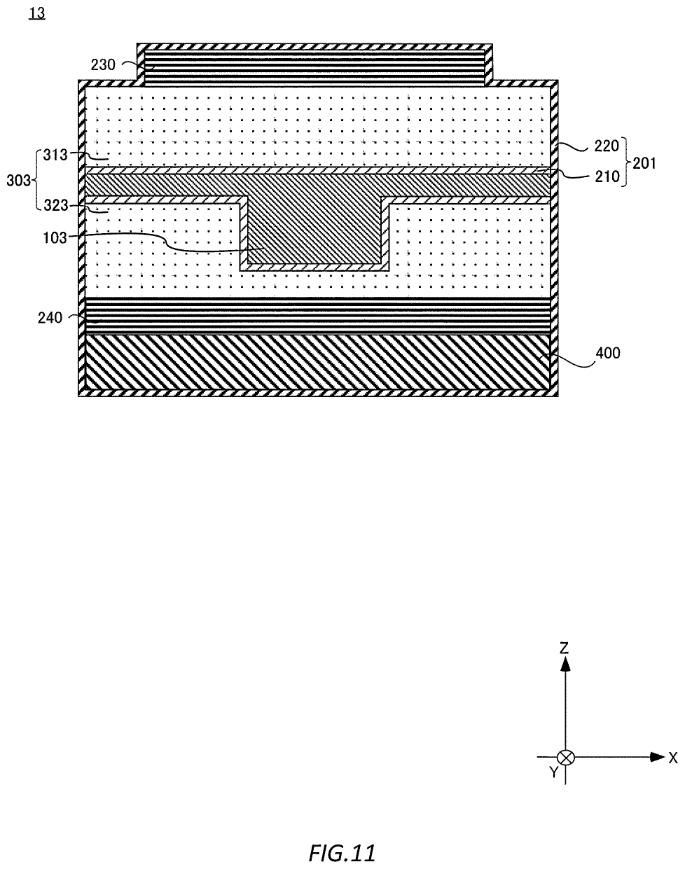

FIG. 11 schematically illustrates a cross-sectional view of an optical waveguide 13 according to a third embodiment. The optical waveguide 13 according to the third embodiment includes an optical propagation path 103 with a cross section in a lower convex shape instead of the optical propagation path 101 with a rectangle cross section, which is a different point from the optical waveguide 11 according to the first embodiment. In the optical waveguide 13 according to the third embodiment, the cladding 303 has a combination of an upper cladding 313 and a lower cladding 323 instead of the combination of the upper cladding 311 and the lower cladding 321, which is a further different point from the optical waveguide 11 according to the first embodiment.

The optical waveguide 13 with an optical propagation path 103 that has a lower convex shape in a cross section orthogonal to the optical propagation direction can also be referred to as an inverted ridge-type optical waveguide 13 because the protruding portion of the optical propagation path 103 extends in the optical propagation direction like a ridge. The inverted ridge-type optical waveguide 13 can ensure single-mode propagation even if the left-right width of the optical propagation path 103 through which light propagates is relatively large, and thus may be operable in visible light, similar to the ridge-type optical waveguide 12 according to the second embodiment. In the optical waveguide 13 according to the third embodiment, the upper cladding 313 surrounds the upper side of the optical propagation path 103 covered by the first stacked structure 210, and the lower cladding 323 surrounds the lower side of the optical propagation path 103 covered by the first stacked structure 210.

The same effect as the optical waveguide 11 according to the first embodiment can also be obtained by the optical waveguide 13 according to the third embodiment.

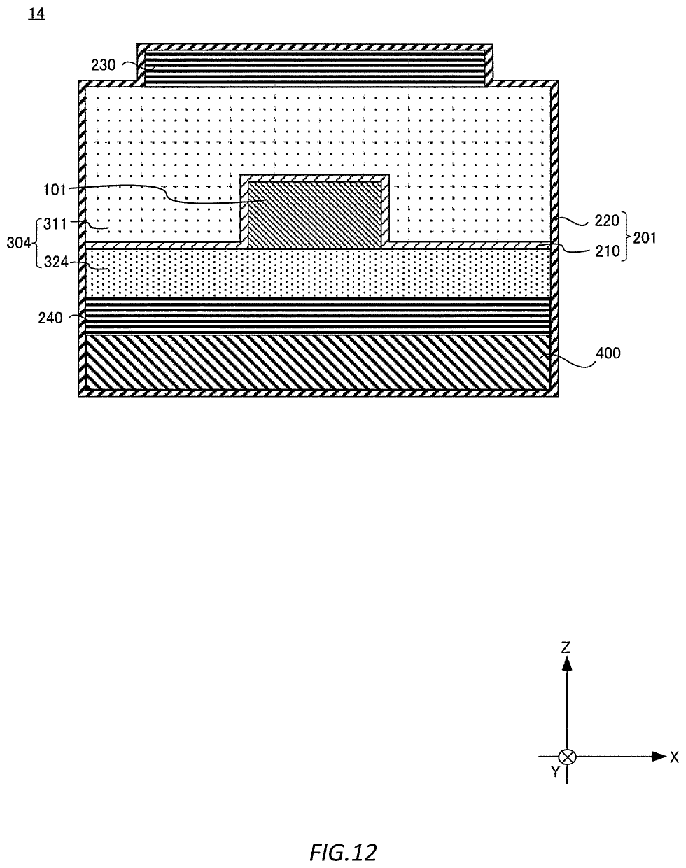

FIG. 12 schematically illustrates a cross-sectional view of an optical waveguide 14 according to a fourth embodiment. In the optical waveguide 14 according to the fourth embodiment, the cladding 304 has a lower cladding 321 instead of a thermal oxide layer 324, which is a different point from the optical waveguide 11 according to the first embodiment.

The thermal oxide layer 324 of the cladding 304 is formed on the main surface on the positive side in the Z-axis direction of the support substrate 400 similar to the lower cladding 321 in the first embodiment. The thermal oxide layer 324 of the cladding 304 surrounds a portion of the perimeter of the optical propagation path 101 that serves as a core as a cladding. The upper cladding 311 of the cladding 304 surrounds the portion not surrounded by the thermal oxide layer 324 in the perimeter of the optical propagation path 101 that serves as the core. That is, the cladding 304 surrounds the perimeter of the optical propagation path 101 that serves as the core by the upper cladding 311 and the thermal oxide layer 324.

The thermal oxide layer 324 contains, for example, SiO₂. The thickness in the Z-axis direction of the thermal oxide layer 324 is 3 μm as an example. The thermal oxide layer 324 is impermeable to moisture and almost impermeable to oxygen.

Therefore, the optical propagation path 101 may not be directly formed on the thermal oxide layer 324 in the optical waveguide 14 according to the fourth embodiment. In the optical waveguide 14 according to the fourth embodiment, the stacked structure 201 is located in at least a portion of the interface between the optical propagation path 101 and the upper cladding 311. More specifically, the first stacked structure 210 of the stacked structure 201 may be located over the entirety of the interface between the optical propagation path 101 and the upper cladding 311.

In the optical waveguide 14 according to the fourth embodiment, the first layer of the stacked structure 201 prevents oxygen from permeating from the upper cladding 311 to the optical propagation path 101, and the second layer of the stacked structure 201 prevents moisture from permeating from the upper cladding 311 to the first layer. More specifically, in the first stacked structure 210 of the stacked structure 201, the first layer 211 and the second layer 212 may correspond to the first layer and the second layer described above.

The same effect as the optical waveguide 14 according to the first embodiment can also be obtained by the optical waveguide 11 according to the fourth embodiment. Since the thermal oxide layer 324 is impermeable to moisture and almost impermeable to oxygen, the stacked structure 201 may not be provided, or the stacked structure 201 may be provided at the interface between the optical propagation path 101 that serves as the core and the thermal oxide layer 324.

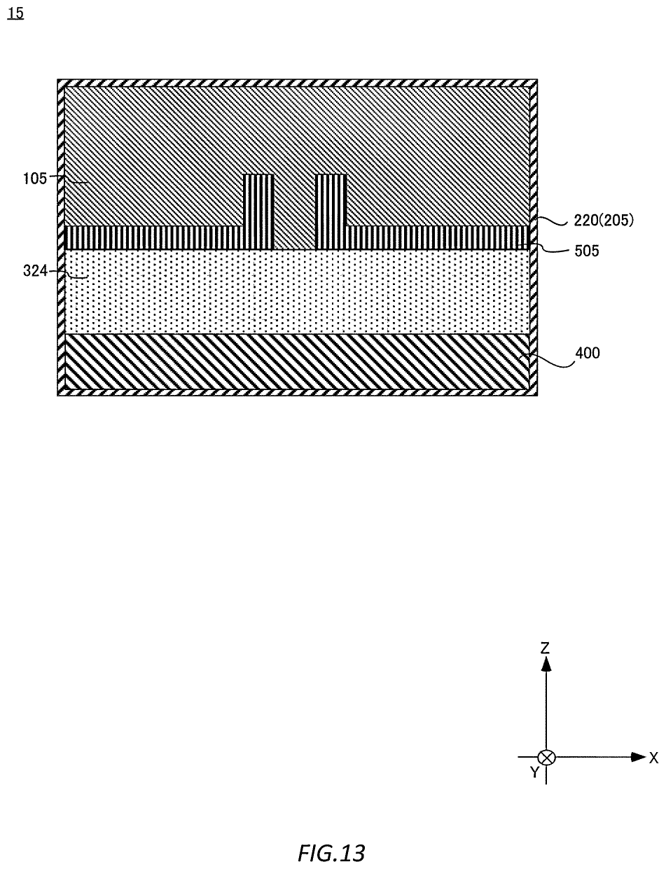

FIG. 13 schematically illustrates a cross-sectional view of the optical waveguide 15 according to the fifth embodiment. The optical waveguide 15 according to the fifth embodiment includes the thermal oxide layer 324, the slot structure 505 and the optical propagation path 105 described above instead of the optical propagation path 101 and the cladding 301, which is a different point from the optical waveguide 11 according to the first embodiment. In the optical waveguide 15 according to the fifth embodiment, the stacked structure 205 only has the second stacked structure 220 instead of the combination of the first stacked structure 210 and the second stacked structure 220, which is a different point from the optical waveguide 11 according to the first embodiment.

The slot structure 505 has a slot extending in the optical propagation direction of the optical waveguide 15, which is formed on the thermal oxide layer 324. The slot structure 505 is formed of, for example, silicon. The silicon composing the slot structure 505 is doped with atoms to lower its resistance, which allows the slot structure 505 to also function as an electrode. A width in the X-axis direction of the slot in the slot structure 505 is, for example, 100 to 200 nm or less.

In the optical waveguide 15 according to the fifth embodiment, the optical propagation path 105 is located inside the slot at least in part, and is formed on the thermal oxide layer 324 inside the slot. As shown in FIG. 13, the optical propagation path 105 may be formed on the slot structure 505 and the thermal oxide layer 324. The optical propagation path 105 may be directly formed on the thermal oxide layer 324 inside the slot.

The optical waveguide 15 where the optical propagation path 105 containing EO polymer between slots of the slot structure 505 is formed may be referred to as a slot waveguide. The optical waveguide 15 that is the slot waveguide can concentrate an electric field between the slots of the slot structure 505 by applying a voltage to the slot structure 505. This allows the optical waveguide 15, which is a slot waveguide, to change the refractive index of the EO polymer in the optical propagation path 105 and control the phase of the light propagating in the optical propagation path 105 between the slots.

In the optical waveguide 15 according to the fifth embodiment, the stacked structure 205 covers the outer surface of the optical propagation path 105. More specifically, the second stacked structure 220 of the stacked structure 205 covers the outer surface of the optical propagation path 105. Accordingly, the second stacked structure 220 of the stacked structure 205 covers the outer surfaces of the optical propagation path 105, the slot structure 505, the thermal oxide layer 324 and the support substrate 400.

In the second stacked structure 220 of the stacked structure 205, for example, the first layer 221 contains Al₂O₃, the second layer 222 contains at least one of SiO₂ or SiN, and the third layer 223 contains SiO₂. Since the second stacked structure 220 is formed at a place away from the place between the slots described above for optical propagation, the second layer 222 and the third layer 223 may include different materials from each other. More specifically, the third layer 223 of the second stacked structure 220 contains SiO₂, on the other hand, the outermost second layer 222 may contain SiN. In this case, in the three-layer structure of the second stacked structure 220, each layer becomes to contain a different material from each other, for example, SiN, Al₂O₃, SiO₂ may be stacked in sequence from the outside.

The same effect as the optical waveguide 11 according to the first embodiment can also be obtained by the optical waveguide 15 according to the fifth embodiment. Since the thermal oxide layer 324 is impermeable to moisture and almost impermeable to oxygen, the stacked structure 205 may not be provided, or the stacked structure 205 may be provided at the interface between the optical propagation path 105 that serves as the core and the thermal oxide layer 324. That is, the stacked structure 205 may be located in at least a portion of the interface between the optical propagation path 105 and a set of the thermal oxide layer 324 and the slot structure 505. More specifically, the stacked structure 205 may be additionally located over the entirety of the interface between the optical propagation path 105 and the set of the thermal oxide layer 324 and the slot structure 505. In this case, in the portion located at the interface in the stacked structure 205, the first layer 221 may contain Al₂O₃, and the second layer 222 and the third layer 223 may contain SiO₂.

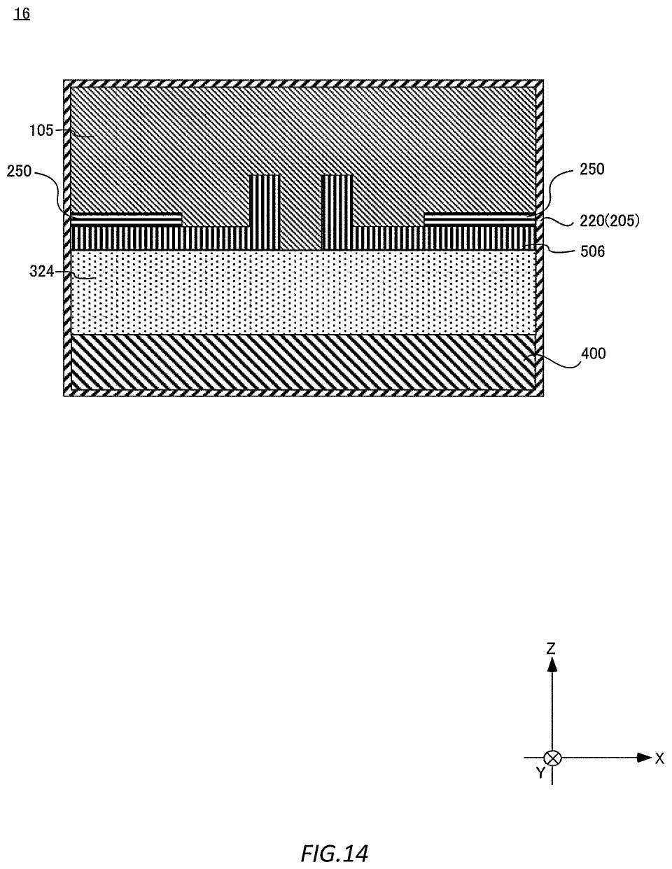

FIG. 14 schematically illustrates a cross-sectional view of an optical waveguide 16 according to a sixth embodiment. The optical waveguide 16 according to the sixth embodiment includes a slot structure 506 instead of the slot structure 505, and further includes an inner electrode 250, which is a different point from the optical waveguide 15 according to the fifth embodiment.

The slot structure 506 may have a structure similar to the slot structure 505 in the fifth embodiment, that is, may have a slot that is formed on the thermal oxide layer 324 and extends in the optical propagation direction of the optical waveguide 16. The slot structure 506 may contain oxide or nitride with a refractive index larger than the EO polymer. In this case, the slot structure 506 may, for example, contain titanium dioxide (TiO₂), SiN, or the like.

The inner electrode 250 is disposed on a flat surface along the XY plane in the slot structure 506, located at the interface between the slot structure 506 and the optical propagation path 105 on each of the left and right sides of the slot of the slot structure 506. In addition to this, on each of the walls facing the slot in the X-axis direction, the inner electrode 250 may extend onto the surface of the opposing side of the inner surface facing the other wall, that is, onto the outer surface of each wall. The same effect as the optical waveguide 16 according to the sixth embodiment can also be obtained by the optical waveguide 11 according to the first embodiment.

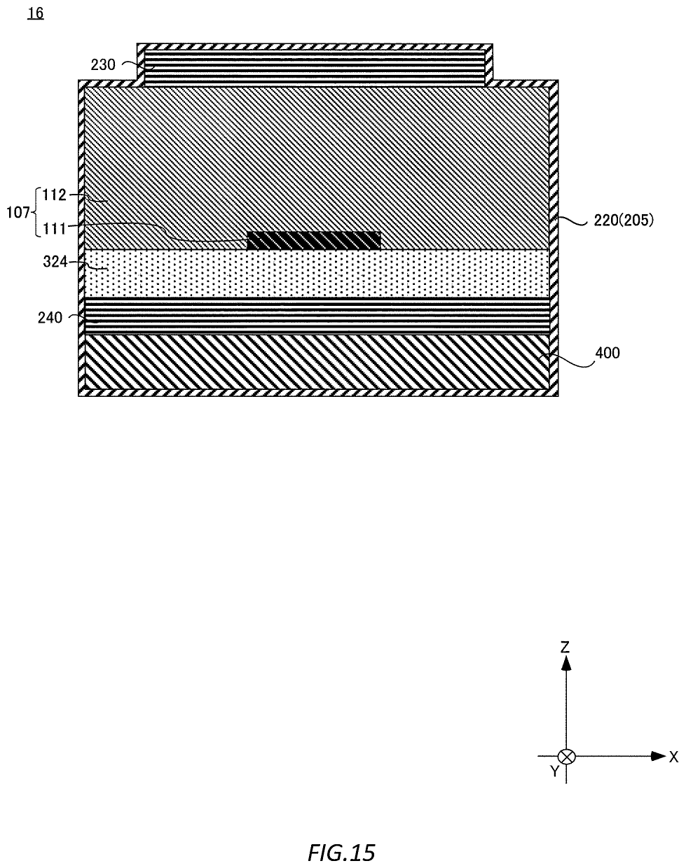

FIG. 15 schematically illustrates a cross-sectional view of an optical waveguide 17 according to a seventh embodiment. The optical waveguide 17 according to the seventh embodiment includes the optical propagation path 107 and the thermal oxide layer 324 described above instead of the optical propagation path 101 and the cladding 301, which is a different point from the optical waveguide 11 according to the first embodiment. In the optical waveguide 17 according to the seventh embodiment, the stacked structure 205 only has the second stacked structure 220 instead of the combination of the first stacked structure 210 and the second stacked structure 220, which is a further different point from the optical waveguide 11 according to the first embodiment.

In the optical waveguide 17 according to the seventh embodiment, the optical propagation path 107 has a high refractive index core 111 and an EO cladding 112. The high refractive index core 111 extends in the optical propagation direction of the optical waveguide 17. The high refractive index core 111 contains oxide or nitride with a refractive index larger than the EO polymer. The high refractive index core 111 may contain TiO₂, SiN or the like. The EO cladding 112 partially surrounds the perimeter of the high refractive index core 111. The EO cladding 112 contains EO polymer.

In the optical waveguide 17 according to the seventh embodiment, the thermal oxide layer 324 surrounds, as a cladding, the portion that is not surrounded by the EO cladding 112 of the optical propagation path 107 in the perimeter of the high refractive index core 111 of the optical propagation path 107. That is, in the optical waveguide 17 according to the seventh embodiment, the EO cladding 112 and the thermal oxide layer 324 of the optical propagation path 107 surround the perimeter of the high refractive index core 111 of the optical propagation path 107.

In the optical waveguide 17 with such a configuration, light is propagated inside the high refractive index core 111. When the thickness in the Z-axis direction of the high refractive index core 111 is a predetermined magnitude or less, light is propagated not only inside the high refractive index core 111, but also in the EO cladding 112, where it seeps into the portion close to the high refractive index core 111. In the EO cladding 112, the upper electrode 230 described above is disposed. In the optical waveguide 17, an electric field is applied to the EO cladding 112 by applying a voltage to the upper electrode 230 on the EO cladding 112 and the lower electrode 240 on the support substrate 400, and this changes the refractive index of the EO polymer of the EO cladding 112, and the phase of light propagating through the optical propagation path 107 can be controlled as it seeps into the EO cladding 112.

In the optical waveguide 17 according to the seventh embodiment, the stacked structure 205 covers the outer surfaces of the EO cladding 112 of the optical propagation path 107. More specifically, the second stacked structure 220 of the stacked structure 205 covers the outer surfaces of the EO cladding 112 of the optical propagation path 107. Accordingly, the second stacked structure 220 of the stacked structure 205 covers the outer surfaces of the EO cladding 112 of the optical propagation path 107, the thermal oxide layer 324 and the support substrate 400.

In the second stacked structure 220 of the stacked structure 205, for example, the first layer 221 contains Al₂O₃, the second layer 222 contains at least one of SiO₂ or SiN, and the third layer 223 contains SiO₂. Since the second stacked structure 220 is formed at a place away from the high refractive index core 111 for optical propagation, the second layer 222 and the third layer 223 may include different materials from each other. More specifically, the third layer 223 of the second stacked structure 220 contains SiO₂, on the other hand, the outermost second layer 222 may contain silicon nitride (SiN). In this case, in the three-layer structure of the second stacked structure 220, each layer becomes to contain a different material from each other, for example, SiN, Al₂O₃, SiO₂ may be stacked in sequence from the outside.

The same effect as the optical waveguide 11 according to the first embodiment can also be obtained by the optical waveguide 17 according to the seventh embodiment. Since the thermal oxide layer 324 is impermeable to moisture and almost impermeable to oxygen, the stacked structure 205 may not be provided, or the stacked structure 205 may be provided at the interface between the EO cladding 112 and the thermal oxide layer 324. That is, the stacked structure 205 may be located in at least a portion of the interface between the EO cladding 112 of the optical propagation path 107 and a set of the thermal oxide layer 324 and the high refractive index core 111 of the optical propagation path 107. More specifically, the stacked structure 205 may additionally be located over the entirety of the interface between the EO cladding 112 of the optical propagation path 107 and a set of the thermal oxide layer 324 and the high refractive index core 111 of the optical propagation path 107. In this case, in the portion located at the interface in the stacked structure 205, the first layer 221 may contain Al₂O₃, and the second layer 222 and the third layer 223 may contain SiO₂.

In the plurality of embodiments described above, the optical waveguide may further include a film containing polyimide, which covers at least a portion of the stacked structure. Moisture hardly permeates a film containing polyimide. Accordingly, in this case, the optical waveguide may be able to further suppress the occurrence of pinholes on the first layer of the stacked structure. In this case, the optical waveguide may be able to relax the stress when depositing the stacked structure by the film containing polyimide. The film containing polyimide may be the outermost layer of the stacked structure. The optical waveguide may further include another film that covers at least a portion of the stacked structure in addition to or instead of the film containing polyimide.

While the present invention has been described with the embodiments, the technical scope of the present invention is not limited to the above-described embodiments. It is apparent to persons skilled in the art that various alterations or improvements can be added to the above-described embodiments. It is also apparent from the description of the claims that embodiments added with such alterations or improvements can be included in the technical scope of the present invention.

Note that the operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the operation flow is described by using phrases such as “first” or “next” in the scope of the claims, specification, or drawings, it does not necessarily mean that the process must be performed in this order.

### EXPLANATION OF REFERENCES

11: optical waveguide; 101, 101′: optical propagation path; 201: stacked structure; 210, 210′: first stacked structure; 211: first layer; 212: second layer; 213: third layer; 220: second stacked structure; 221: first layer; 222: second layer; 223: third layer; 230: upper electrode; 240: lower electrode; 301: cladding; 311: upper cladding; 321: lower cladding; 400: support substrate; 12: optical waveguide; 102: optical propagation path; 302: cladding; 312: upper cladding; 13: optical waveguide; 103: optical propagation path; 303: cladding; 313: upper cladding; 323: lower cladding; 14: optical waveguide; 304: cladding; 324: thermal oxide layer; 15: optical waveguide; 105: optical propagation path; 205: stacked structure; 505: slot structure; 16: optical waveguide; 250: inner electrode; 506: slot structure; 17: optical waveguide; 107: optical propagation path; 111: high refractive index core; 112: EO cladding.

What is claimed is:

1. An optical waveguide, comprising:
an optical propagation path containing an organic electro-optic polymer material; and
a stacked structure covering at least a portion of the optical propagation path, having a first layer to prevent oxygen from permeating into the optical propagation path from outside, and a second layer to prevent moisture from permeating into the first layer from the outside.

2. The optical waveguide according to claim 1, wherein the first layer contains Al₂O₃, and the second layer contains SiO₂.

3. The optical waveguide according to claim 1, wherein the stacked structure has a three-layer structure consisting of the second layer, the first layer, and a third layer that prevents moisture permeation from the optical propagation path to the first layer, stacked in sequence.

4. The optical waveguide according to claim 3, wherein the first layer contains Al₂O₃, and the second layer and the third layer contain SiO₂.

5. The optical waveguide according to claim 4, wherein a thickness of the stacked structure is from 4 nm to 100 nm.

6. The optical waveguide according to claim 1, further comprising a film containing polyimide covering at least a portion of the stacked structure.

7. The optical waveguide according to claim 1, further comprising
a cladding surrounding a perimeter of the optical propagation path that serves as a core,
wherein the stacked structure has a first stacked structure located in at least a portion of an interface between the optical propagation path and the cladding, and in the first stacked structure, the first layer prevents oxygen permeation from the cladding to the optical propagation path and the second layer prevents moisture permeation from the cladding to the first layer.

8. The optical waveguide according to claim 7, wherein the first stacked structure is located over an entirety of the interface.

9. The optical waveguide according to claim 7, wherein the stacked structure further has a second stacked structure covering an optical entering surface and an optical emitting surface of the optical propagation path.

10. The optical waveguide according to claim 9, further comprising
a support substrate having the cladding formed on a main surface,
wherein the second stacked structure further covers outer surfaces of the cladding and the support substrate.

11. The optical waveguide according to claim 1, further comprising:
a thermal oxide layer that surrounds a portion of a perimeter of the optical propagation path that serves as a core as a first cladding; and
a second cladding that surrounds a portion not surrounded by the thermal oxide layer in the perimeter of the optical propagation path that serves as a core,
wherein the optical propagation path is directly formed on the thermal oxide layer; and
wherein the stacked structure has a first stacked structure located in at least a portion of an interface between the optical propagation path and the second cladding, and in the first stacked structure, the first layer prevents oxygen permeation from the second cladding to the optical propagation path, and the second layer prevents moisture permeation from the second cladding to the first layer.

12. The optical waveguide according to claim 1, further comprising:
a thermal oxide layer; and
a slot structure formed on the thermal oxide layer, having a slot extending in an optical propagation direction,
wherein the optical propagation path is located at least partially inside the slot and formed on the thermal oxide layer inside the slot, and
wherein the stacked structure covers an outer surface of the optical propagation path.

13. The optical waveguide according to claim 12, wherein the optical propagation path is directly formed on the thermal oxide layer inside the slot.

14. The optical waveguide according to claim 12, wherein the stacked structure is further located in at least a portion of an interface between the optical propagation path and a set of the thermal oxide layer and the slot structure.

15. The optical waveguide according to claim 12, wherein the slot structure contains oxide or nitride with a greater refractive index than that of the organic electro-optic polymer material.

16. The optical waveguide according to claim 1, wherein:
the optical propagation path has a core containing oxide or nitride with a greater refractive index than the organic electro-optic polymer material, extending in an optical propagation direction, and a first cladding containing the organic electro-optic polymer material, partially surrounding a perimeter of the core;
the optical waveguide further comprises a thermal oxide layer that surrounds a portion not surrounded by the first cladding of the optical propagation path as a second cladding in the perimeter of the core of the optical propagation path; and
the stacked structure covers an outer surface of the optical propagation path.

17. The optical waveguide according to claim 16, wherein the optical propagation path is directly formed on the thermal oxide layer.

18. The optical waveguide according to claim 16, wherein the stacked structure is further located in at least a portion of an interface between the first cladding of the optical propagation path and a set of the thermal oxide layer and the core of the optical propagation path.

19. The optical waveguide according to claim 12, wherein the first layer contains Al₂O₃, and the second layer contains at least one of SiO₂ or SiN.

20. The optical waveguide according to claim 9, wherein the second stacked structure covers an outer surface of the optical propagation path.

21. The optical waveguide according to claim 11, wherein the first stacked structure is located over an entirety of the interface.

22. The optical waveguide according to claim 11, wherein the stacked structure further has a second stacked structure covering an optical entering surface and an optical emitting surface of the optical propagation path.

23. A manufacturing method of an optical waveguide, comprising:
forming an optical propagation path containing an organic electro-optic polymer material; and
forming a stacked structure covering at least a portion of the optical propagation path, having a first layer to prevent oxygen from permeating into the optical propagation path from outside, and a second layer to prevent moisture from permeating into the first layer from the outside.
